(19) United States
(12) Patent Application Publication
(10) Pub. No.: US 2013/0290688 A1
(43) Pub. Date: Oct. 31, 2013

(54) Method of Concurrent Instruction Execution and Parallel Work Balancing in Heterogeneous Computer Systems

(71) Applicant: Stanislav Victorovich Bratanov, Nizhniy Novgorod (RU)

(72) Inventor: Stanislav Victorovich Bratanov, Nizhniy Novgorod (RU)

(21) Appl. No.: 13/867,803

(22) Filed: Apr. 22, 2013

(51) Int. Cl. G06F 9/38

(52) U.S. Cl. CPC G06F 9/3851
USPC 712/228

(57) ABSTRACT

Embodiments of the present invention provide for concurrent instruction execution in heterogeneous computer systems by forming a parallel execution context whenever a first software thread encounters a parallel execution construct. The parallel execution context may comprise a reference to instructions to be executed concurrently, a reference to data said instructions may depend on, and a parallelism level indicator whose value specifies the number of times said instructions are to be executed. The first software thread may then signal to other software threads to begin concurrent execution of instructions referenced in said context. Each software thread may then decrease the parallelism level indicator and copy data referenced in the parallel execution context to said thread's private memory location and modify said data to accommodate for the new location. Software threads may be executed by a processor and operate on behalf of other processing devices or remote computer systems.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field

Embodiments of the present invention relate generally to methods of parallel task execution and, more specifically, to efficient methods of task scheduling and work balancing in symmetric multiprocessor systems that may be coupled with processing accelerator devices and/or connected with remote computer systems.

2. Description

Parallel computer systems penetrated into almost every aspect of modern technology, and parallel computing is considered by many experts as the only way of ensuring further growth of the compute-power of future computer systems and their applicability to new areas of science and technology. That brings the problem of increasing efficiency of concurrent computations, maximizing processing resource utilization and minimizing efforts spent on parallel programming to the foreground.

Unfortunately, modern parallel computing systems have certain disadvantages, which decrease the efficiency of concurrent instruction execution. Those disadvantages are typically caused by software models employed in modern parallel computer system programming. For example, there is a concept of ‘task’, known from the prior art, which implies decomposing parallel execution into portions of code to be executed concurrently and portions of data said code can operate on (collectively known as tasks). While the task concept enabled the progress in parallel programming and especially in parallel work balancing, it is not without a flaw.

Thus, to initiate concurrent execution of instructions, a set of tasks has to be generated from those instructions and from data their execution may depend on. Then, said tasks have to be queued, that is, the system needs to form one or more lists from which software threads will be picking up tasks for execution. The process of task queuing consumes time (to divide data between tasks and allocate memory for task descriptors) and memory resources (to hold task descriptors and maintain linked lists and queues): the more tasks the higher execution time and memory penalties, which negatively affects the overall performance of parallel computations.

Solving the problem of parallel work load balancing to maximize the utilization of processing resources also comes at a cost: software threads which complete execution of tasks and, consequently, whose task queues become empty have to access other threads' task queues to retrieve more tasks for execution and re-divide data between new tasks—thus blocking those other software threads from executing tasks from their tasks queues—which also negatively affects the overall performance of parallel computations.

Many modern computer systems (ranging from super-computers to mobile devices) are equipped with processing accelerator devices, which are used to increase the efficiency of parallel computations by taking part of the work load off the central processors (known in the art as heterogeneous computer systems). Typically, such systems are programmed using dedicated, highly specialized programming languages and environments, which in many cases cannot be efficiently applied to programming central processors, thus further increasing the complexity of parallel programming and inheriting all of the aforementioned limitations with regard to parallel work balancing.

Therefore, a need exists for the capability to accelerate concurrent execution of instructions, increase utilization of processing resources, minimize memory resource utilization, decrease parallel work balancing overhead, and simplify programming of heterogeneous computer systems.

### BRIEF DESCRIPTION OF THE DRAWINGS

The features and advantages of the present invention will become apparent from the following detailed description of the present invention in which:

FIG. 1 is a diagram illustrating an exemplary computer system to which embodiments of the present invention may apply;

FIG. 2 is a flow diagram illustrating the process of forming a parallel execution context when a request for concurrent execution of instructions is received or a parallel execution construct is encountered, according to an embodiment of the present invention; and

FIG. 3 is a flow diagram illustrating the process of concurrent instruction execution by parallel software threads in accordance with an embodiment of the present invention.

### DETAILED DESCRIPTION

An embodiment of the present invention is a method that provides for efficient execution of instructions concurrently by multiple software or hardware threads and for maximizing utilization of processing resources in heterogeneous computer systems.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

The following definitions may be useful for understanding embodiments of the present invention described herein.

Software thread is a stream of instructions to be executed independently by one or more processors, associated with software execution context, which may comprise values of processor registers and memory locations according to particular hardware logic designs and software execution conventions.

Hardware thread denotes a processor that maintains an independent software execution context and is visible as an independent processor to the operating system and system software.

Processing device comprises one or more processors, optionally coupled with memory, which are connected with central processors within the same computer system and, as a general rule, are not visible as independent processors to the operating system. Processing devices, in order to execute instructions, typically have to be programmed by software threads that are executed by central processors.

Remote computer systems are computer systems comprising any combination of central processors, processing devices and memory storage and connected with other such systems by means of a communication device, e.g., a network interface card.

Stack memory denotes a memory region containing procedure linkage information and other data to be accessed exclusively by one software thread in accordance with software execution conventions.

Stack frame is a region of stack memory that stores data specific to a single procedure or function being executed by a software thread in accordance with software execution conventions.

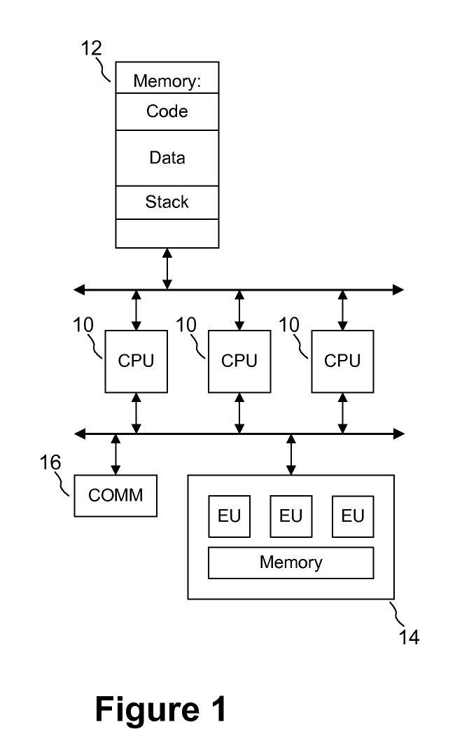

FIG. 1 is a diagram illustrating an exemplary computer system to which embodiments of the present invention may apply.

According to the figure, a system embodying the present invention may comprise processors 10 (referred to in the figure as CPU, or central processing units), which may be coupled with memory 12, processing device 14, and communication device 16. Processors 10 may execute software threads, at least one software thread per processor. Said software threads may comprise instructions stored in a code region of memory 12. All software threads may have access to data stored in a data region of memory 12, and each software thread may exclusively access data stored in a stack region of memory 12.

In one embodiment of the present invention processing device 14 may comprise multiple execution units (EU) and memory containing instructions and data to be accessed by the execution units. While in other embodiments of the present invention processing device 14 may have direct access to instructions and data stored in memory 12.

One skilled in the art will recognize that systems embodying the present invention may comprise any combination of central processors and processing devices, of different hardware architecture and capabilities. Furthermore, one skilled in the art will recognize the option of employing dedicated software threads executed by processor 10 to program processing devices 14 with instructions to execute, and to transfer input and output data to and from said devices.

In an embodiment of the present invention communication device 16 may be employed for transferring instructions and data to remote computer systems for execution and retrieving results.

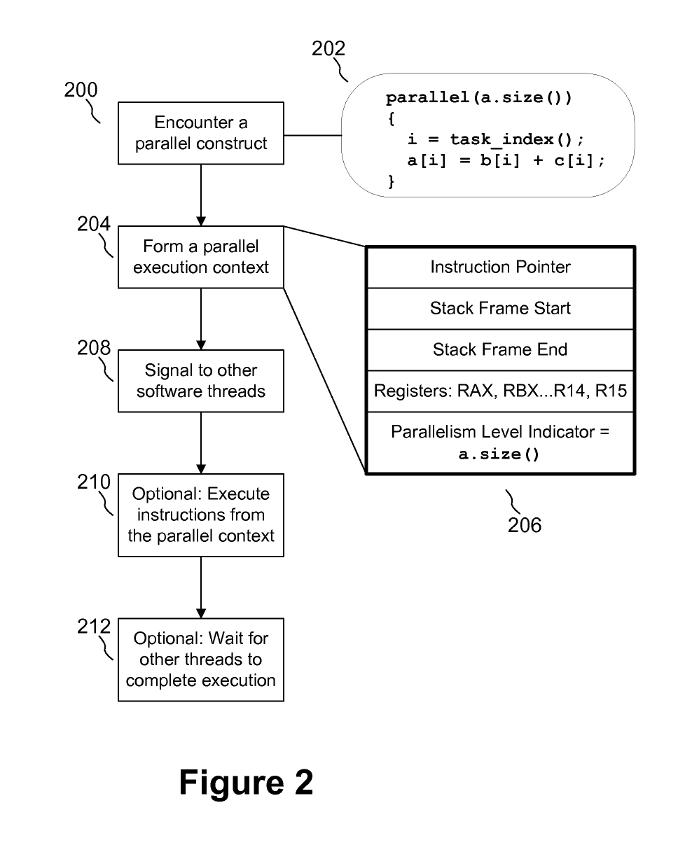

FIG. 2 is a flow diagram illustrating the process of forming a parallel execution context when a request for concurrent execution of instructions is received or a parallel execution construct is encountered, according to an embodiment of the present invention.

According to the figure, a software thread, during its normal course of execution, may encounter a parallel execution construct or otherwise receive a request for parallel execution at block 200. An exemplary parallel execution construct is provided in block 202 and may comprise instructions to execute (instruction block in braces “{ }” in the example of this figure), data said instructions may depend on (arrays “a”, “b”, and “c” in the example if this figure), and an indication (explicit or implicit, direct or indirect) of the level of parallelism, i.e., the number of times the instruction block can be executed (in the example of block 202 the parallelism level equals the size of array “a”). It should be noted here that the problem of generating the actual code capable of correct concurrent execution lies beyond the scope of the present invention, while the present invention provides for means of efficient execution of such code.

Then, the software thread may form a parallel execution context at block 204. The parallel execution context may comprise, as illustrated in block 206, an instruction pointer, i.e., an address of the beginning of an instruction block to be executed concurrently; an address of the beginning of a current stack frame (referred to as Stack Frame Start); an address of the end of the current stack frame (referred to as Stack Frame End); current contents of processor registers; and a parallelism level indicator (initialized to the size of array “a” according to the example of block 202). In one embodiment of the present invention forming the parallel execution context may comprise allocating the memory structure of block 206 on the software thread's stack memory.

One skilled in the art will recognize the option of employing different means of forming the parallel execution block according to different software execution conventions. Furthermore, one skilled in the art will recognize that in other embodiments of the present invention the parallel execution context may comprise different fields to locate thread-specific data, and different processor registers as may be appropriate for certain software execution conventions or hardware architectures.

Then, at block 208, the software thread may signal to other threads that a parallel execution context is available. In one embodiment of the present invention signaling to other threads may comprise using semaphores or other conventional means of software thread synchronization provided by an operating system; while other embodiments may employ inter-processor interrupts or other means of hardware thread signaling as may be provided by a computer system.

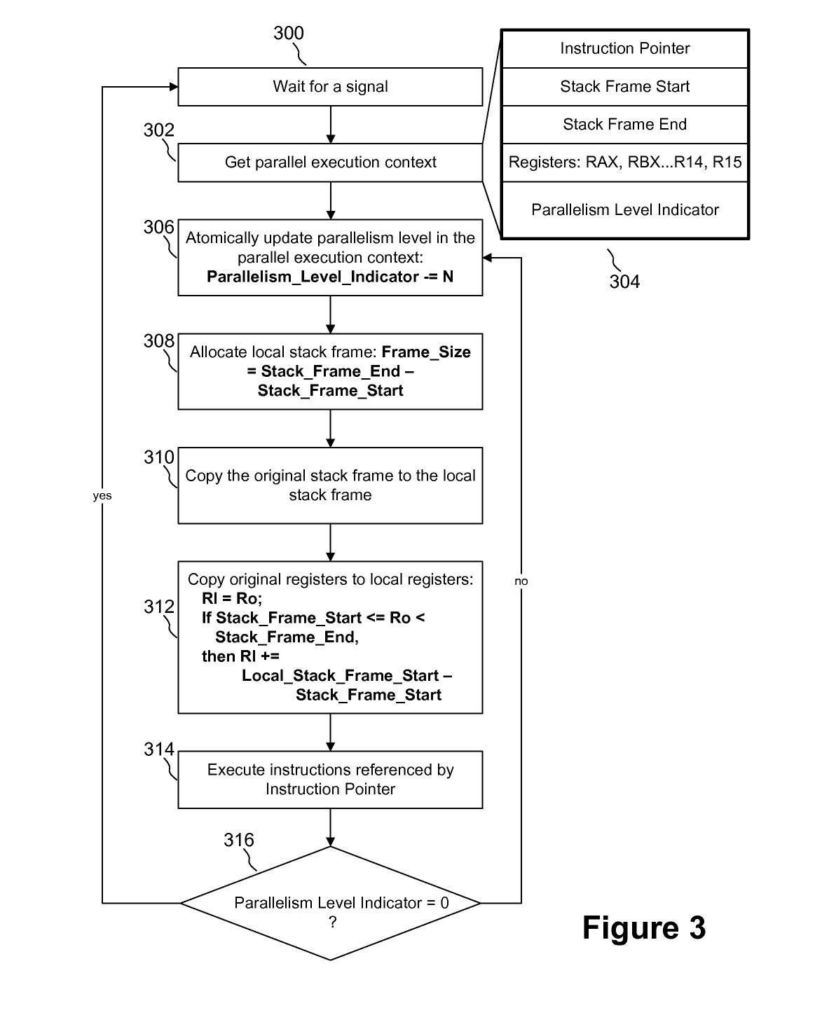

Finally, at block 210, the software thread may optionally execute instructions from the parallel execution context (as will be further described in the example of FIG. 3), and wait for other threads to complete their operation at block 212.

FIG. 3 is a flow diagram illustrating the process of concurrent instruction execution by parallel software threads in accordance with an embodiment of the present invention.

According to the figure, software threads may wait for a signal at block 300 to begin concurrent execution. Then, upon reception of the signal, at block 302, each software thread may retrieve parallel execution context 304. Then, at block 306, each thread may decrease the parallelism level indicator of the parallel execution context by N, wherein N corresponds to the number of times the software thread (or the processing device on whose behalf the thread operates) is capable of executing instructions of the parallel execution context. For example, software threads operating on behalf of central processors may typically decrement the parallelism level indicator by one, as traditional CPU architectures provide for execution of only one software thread per hardware thread at a time. While software threads operating on behalf of other processing devices may decrement the parallelism level indicator at least by the number of execution units available in said devices.

Further, at block 308, each software thread may allocate a local stack frame to contain thread-specific data. The size of the local stack frame may be determined as a difference between Stack Frame End and Stack Frame Start fields of the parallel execution context. At block 310, each software thread may copy the contents of the original stack frame referenced in the parallel execution context (Stack Frame Start) to the newly allocated local stack frame. Then, at block 312, each software thread may copy original register contents (referenced as Ro in the example of the figure) from the parallel execution context to local processor registers (referenced as RI in the example of the figure). After copying each register value, a check may be performed if the original register value lies within the borders of the original stack frame, and if the above condition is true, the local register value may be increased by a difference between addresses of the beginnings of the local stack frame (allocated at block 310) and the original stack frame—thus effectively enabling local processor register values to contain addresses within the local stack frame. For example, if an original register contains an address of a variable located in the original stack frame, the local register will contain the address of that variable's copy in the local stack frame.

Finally, each software thread may proceed with executing instructions referenced by the instruction pointer of the parallel execution context at block 314, and, upon completion, perform a check at block 316 of whether the parallelism level indicator becomes zero. In case the parallelism level indicator is zero, the control may be returned to block 300; otherwise, the control may return to block 306 and concurrent execution of instructions from the current parallel execution context may continue.

Different embodiments of the present invention may utilize different processor registers in the parallel execution context, as may be appropriate to comply with a particular hardware architecture and software execution convention which may be in effect in a system embodying the present invention. Similarly, if a hardware architecture or software execution convention so dictates, an embodiment of the present invention may employ any reference to data to be accessed exclusively by a software thread, other than the stack memory.

Embodiments of the present invention provide for dynamic work load balancing between multiple processors, in a manner that is adaptive to the actual work complexity and performance of a particular processor, by ensuring that a software thread that completes operations at block 314 faster than other software threads may proceed to block 306 faster and retrieve more work for execution. Persons skilled in the art will recognize that dynamic work load balancing may be performed without introducing additional memory structures for maintaining task queues and extra operations for task queue re-balancing, which further differentiates the present invention from the prior art.

For C and C++ language examples of embodiments of the present invention refer to Appendices A and B, wherein Appendix A comprises a program that illustrates the use of concurrent operations for computing a set of Fibonacci numbers; and Appendix B furnishes an exemplary implementation of a run-time library that enables code execution by multiple concurrent threads and automatic parallel work balancing. The provided code excerpts do not constitute a complete concurrent instruction execution system, are provided for illustrative purposes, and should not be viewed as a reference implementation with regard to both their functionality and efficiency.

One skilled in the art will recognize the option of employing different data types and thread interaction schemes as may be appropriate for a given operating system or programming environment while still remaining within the spirit and scope of the present invention. Furthermore, one skilled in the art will recognize that embodiments of the present invention may be implemented in other ways and using other programming languages.

The techniques described herein are not limited to any particular hardware or software configuration; they may find applicability in any computing or processing environment. The techniques may be implemented in logic embodied in hardware components. The techniques may be implemented in programs executing on programmable machines such as mobile or stationary computers, personal digital assistants, set top boxes, cellular telephones and pagers, and other electronic devices, that each include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various computer system configurations, including multiprocessor systems, minicomputers, mainframe computers, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine readable medium having stored thereon instructions that may be used to program a processing system or other electronic device to perform the methods. The term “machine readable medium” used herein shall include any medium that is capable of storing or encoding a sequence of instructions for execution by the machine and that cause the machine to perform any one of the methods described herein. The term “machine readable medium” shall accordingly include, but not be limited to, solid-state memories, optical and magnetic disks. Furthermore, it is common in the art to speak of software, in one form or another (e.g., program, procedure, process, application, module, and so on) as taking an action or causing a result. Such expressions are merely a shorthand way of stating the execution of the software by a processing system to cause the processor to perform an action or produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

### APPENDIX A

A C++ code example of parallel task execution and automatic work balancing. The goal of this code is to compute an array of Fibonacci numbers of different orders concurrently in multiple software threads. The code specifies the total length of the Fibonacci array as the maximal potential level of parallelism, and lets the runtime system automatically decide on the actual number of threads of execution and work distribution.

All provided code excerpts do not constitute a complete concurrent execution system, are provided for illustrational purposes, and should not be viewed as a reference implementation with regard to both functionality and efficiency. Some of the provided code excerpts, being inessential for the purposes of the present invention, may be optionally included in embodiments of the present invention.

| | |
|---|---|
| int fibonacci(int n) | /// compute the Fibonacci number of order n |

```
{
  if(n < 2)
  {
```

return n;

```
  }
  return fibonacci(n − 1) + fibonacci(n − 2);
}
void foreach( )
{
```

/// allocate an array of Fibonacci numbers to compute
std::vector<int> a;
std::vector<int>* shared ap = &a;
a.push_back(41);
a.push_back(24);
a.push_back(26);
a.push_back(42);
/// output vector
std::vector<int> v;
std::vector<int>* shared vp = &v;
/// pre-allocate the output space
v.insert(v.begin( ), (const int)a.size( ), 0);
/// decompose into one task per element to balance the work
dynamically
parallel(a.size( ))
{

| | |
|---|---|
| int i = pix( ); | /// get the current task's parallel index |

/// compute the task's Fibonacci number and save it
(*vp)[i] = fibonacci((*ap)[i]);
barrier( );

}
/// print the results
std::cout << ”Fibonacci: “;
for(std::vector<int>::iterator i = v.begin( ); i < v.end( ); i++)
{

std::cout << *i << “ ”;

}
std::cout << std::endl;

}

### APPENDIX B

### ©2007 Intel Corporation

A C code example of a parallel execution system. The goal of this code is to retrieve a parallel execution context, copy data referenced in said context to a software thread's stack memory, copy register values from said context to a software thread's local register context, locate registers that contain pointers to the original data referenced in the parallel execution context, and then modify said registers to make them point to the new data locations on the software thread's stack. Then transfer control to an instruction pointer referenced in the parallel execution context and repeat the procedure until there's no more work left to do for said parallel execution context.

All provided code excerpts do not constitute a complete concurrent execution system, are provided for illustrational purposes, and should not be viewed as a reference implementation with regard to both functionality and efficiency. Some of the provided code excerpts, being inessential for the purposes of the present invention, may be optionally included in embodiments of the present invention.

/// Parallel Runtime Library implementation example
typedef struct
{

size_t stk_bottom;
size_t stk_frame;
ucontext_t regs;

} cpx_datatype_execution_context;
struct _cpx_datatype_tls_context;
typedef enum {cpx_const_task = 0, cpx_const_thread = 1} cpx_datatype_partype;
typedef struct _cpx_datatype_region_context
{

| /// backward compatibility | |
|---|---|
| size_t version; | |
| /// parallel execution type | |
| volatile cpx_datatype_partype type; | |
| /// operating context | |
| int pix; | /// current parallel index |
| int pno; | /// size of parallel region |
| volatile long busy; | /// unsafe-to-return flag |
| volatile long lcount; | /// tasks to launch |
| volatile long bcount; | /// tasks on barrier |
| /// context references | |
| struct _cpx_datatype_tls_context* head; | /// main task's TLS |
| struct _cpx_datatype_tls_context* curr; | /// current TLS |

| | |
|---|---|
| struct _cpx_datatype_region_context* head_rgn; | /// head region |

| | |
|---|---|
| jmp_buf* idle; | /// idle execution context |

| | |
|---|---|
| struct _cpx_datatype_region_context* prev_nest; | /// saved tls::rgnctx |
| struct _cpx_datatype_region_context* prev task; | /// saved task list head |

/// register context
cpx_datatype_execution_context exectx;

} cpx_datatype_region_context;
/// parallel operator

| #define parallel(...) | | \ |
|---|---|---|
| { | | \ |
| | int cpx_local_region_state = CPX_CONST_STATE_PARALLEL; | \ |
| | size_t cpx_local_opt_arg = cpx_intrinsic_get_arg(1,## _{——}VA_ARGS_{——}, 0); | \ |
| | | \ |
| | cpx_datatype_region_context cpx_local_rgnctx; | \ |
| | cpx_datatype_region_context* cpx_local_rgnctx_ptr; | \ |
| | | \ |
| | struct timespec req = {0, 1000}; | \ |
| | struct timespec rem; | \ |
| | rem.tv_nsec = cpx_local_region_state; | \ |
| | (void)req; (void)rem; | \ |
| | | \ |
| | cpx_local_rgnctx.exectx.stk_frame = | \ |

| | |
|---|---|
| (size_t)_{——}builtin_frame_address(0) + sizeof(void*) * | \ |
| (CPX_MACRO_SHARED_ARGS + 2); | \ |

| | \ |
|---|---|
| cpx_intrinsic_get_tlsctx( )−>ctxset = 0; | \ |
| getcontext(&cpx_local_rgnctx.exectx.regs); | \ |
| | \ |
| if(!cpx_intrinsic_get_tlsctx( )−>ctxset) | \ |
| { | \ |

| | |
|---|---|
| cpx_local_rgnctx_ptr = &cpx_local_rgnctx; | \ |
| cpx_exported_parallel((int)cpx_local_opt_arg, &cpx_local_rgnctx); | \ |

| | |
|---|---|
| } | \ |
| else | \ |
| { | \ |

| | |
|---|---|
| cpx_local_rgnctx_ptr = cpx_intrinsic_get_tlsctx( )−>rgnctx; | \ |
| _{——}sync_fetch_and_sub(&cpx_local_rgnctx_ptr−>head_rgn−>busy, 1); | \ |

}

/// barrier operator (default for parallel regions)

| #define CPX_KEYWORD_BARRIER( ) | | \ |
|---|---|---|
| | ;} | \ |
| | cpx_local_opt_arg = | \ |

| | |
|---|---|
| _{——}sync_fetch_and_sub(&cpx_local_rgnctx_ptr−>head_rgn−>bcount, 1); | \ |

| | \ |
|---|---|
| if (!cpx_local_rgnctx_ptr−>pix) | \ |
| { | \ |

| | |
|---|---|
| if (cpx_local_rgnctx_ptr−>type == cpx_const_task) | \ |
| { | \ |

| | |
|---|---|
| for (;;) | \ |
| { | \ |

| | |
|---|---|
| if (!cpx_exported_pick_nested_job(cpx_local_rgnctx_ptr)) | \ |
| { | \ |

| | |
|---|---|
| if (cpx_local_rgnctx_ptr−>bcount) | \ |
| { | \ |

| | |
|---|---|
| CPX_MACRO_YIELD( ); | \ |

| | |
|---|---|
| } | \ |
| else | \ |
| { | \ |

| | |
|---|---|
| break; | \ |

| | |
|---|---|
| } | \ |

| | |
|---|---|
| } | \ |

| | |
|---|---|
| } | \ |

| | |
|---|---|
| } | \ |
| else | \ |
| { | \ |

| | |
|---|---|
| while (cpx_local_rgnctx_ptr−>bcount) | \ |
| { | \ |
| sem_wait(&cpx_local_rgnctx_ptr−>head−>wakesig); | \ |
| } | \ |

| | |
|---|---|
| } | \ |

| | |
|---|---|
| cpx_local_rgnctx_ptr−>curr−>rgnctx = cpx_local_rgnctx_ptr−>prev_nest; | \ |
| } | \ |
| else | \ |
| { | \ |

| | |
|---|---|
| if (!cpx_local_opt_arg) | \ |
| { | \ |

| | |
|---|---|
| sem_post(&cpx_local_rgnctx_ptr−>head−>wakesig); | \ |

| | |
|---|---|
| } | \ |

| | |
|---|---|
| cpx_local_rgnctx_ptr−>curr−>rgnctx = cpx_local_rgnctx_ptr−>prev_nest; | \ |

| | |
|---|---|
| longjmp(*cpx_local_rgnctx_ptr−>idle, 1); | \ |

}

/// picks up and executes a task, returns 0 when no task is left
int cpx_exported_pick_job( )
{

cpx_datatype_region_context rgnctx;
jmp_buf idle;
cpx_datatype_tls_context* tlsctx = cpx_intrinsic_get_tlsctx( );
/// fetch a task
cpx_intrinsic_lock_task_list( );
if(!cpx_global_task_list_head)
{

cpx_intrinsic_unlock_task_list( );
return 0;

}
/// make a local copy of the parallel region context
memcpy(&rgnctx, cpx_global_task_list_head,

sizeof(cpx_datatype_region_context));

/// adjust the local context
rgnctx.idle = &idle;
rgnctx.type = cpx_const_task;
rgnctx.pix = rgnctx.pno − rgnctx.lcount;
/// adjust the original context and the task list
if(!--cpx_global_task_list head−>lcount)
{

///cpx_global_task_list_head−>free = 1;
cpx_global_task_list_head = rgnctx.prev_task;

}
cpx_intrinsic_unlock_task_list( );
/// execute the task
if(!setjmp(idle))
{

rgnctx.curr = tlsctx;
rgnctx.prev_nest = tlsctx−>rgnctx;
tlsctx−>rgnctx = &rgnctx;
tlsctx−>ctxset = 1;
cpx_intrinsic_swap_exectx(&rgnctx.exectx);

}
/// idle returns here
return cpx_global_task_list_head ? 1 : 0;

}
void cpx_intrinsic_swap_exectx(cpx_datatype_execution_context* exectx)
{

size_t len;
size_t bp, sp, diff;
/// new register context;
ucontext_t* dst = &exectx−>regs;
/// adjust registers
#define FIX_REG(x) ((x) = (bp > (x) && (x) >= sp) ? (x) + diff : (x))
/// allocate new stack
char* frame = alloca(exectx−>stk_frame −

dst−>uc_mcontext.gregs[REG_ESP] + 512);

/// align the new stack.
frame = (char*)((((size_t)frame + 256) & −256) |

(dst−>uc_mcontext.gregs[REG_ESP] & 0xff));

/// copy stack frames
len = (size_t)exectx−>stk_frame − dst−>uc_mcontext.gregs[REG_ESP];
memcpy(frame, (char*)dst−>uc_mcontext.gregs[REG_ESP], len);
/// source base pointer
bp = exectx−>stk_frame;
/// source stack pointer
sp = dst−>uc_mcontext.gregs[REG_ESP];
/// the distance between the destination and source stacks
diff = (size_t)frame − sp;
FIX_REG(dst−>uc_mcontext.gregs[REG_EBP]);
FIX_REG(dst−>uc_mcontext.gregs[REG_EDI]);
FIX_REG(dst−>uc_mcontext.gregs[REG_ESI]);
FIX_REG(dst−>uc_mcontext.gregs[REG_EBX]);
FIX_REG(dst−>uc_mcontext.gregs[REG_ECX]);
FIX_REG(dst−>uc_mcontext.gregs[REG_EDX]);
dst−>uc_mcontext.gregs[REG_ESP] = (size_t)frame;
/// switch contexts
setcontext(dst);

}

What is claimed is:

1. In a computer system, a method of concurrent execution of instructions comprising:
forming a parallel execution context;
copying the parallel execution context;
modifying the parallel execution context; and
executing instructions referenced in said parallel execution context concurrently by multiple threads.

2. The method of claim 1, wherein parallel execution context comprises at least a reference to instructions to be executed concurrently, a reference to data said instruction may depend on, and a parallelism level indicator initialized to the number of times said instructions are to be executed.

3. The method of claim 1, wherein copying the parallel execution context comprises at least duplicating data referenced in said context to enable independent access to said data from multiple threads.

4. The method of claim 1, wherein modifying the parallel execution context comprises at least updating the parallelism level indicator in accordance with the actual number of times a thread executed instructions referenced in the parallel execution context.

5. The method of claim 1, wherein multiple threads comprise software threads executed by processors and operating on behalf of any combination of said processors, other processing devices and computer systems.

6. An article comprising: a machine accessible medium having a plurality of machine readable instructions, wherein when the instructions are executed by a processor, the instructions provide for concurrent execution of instructions by:
forming a parallel execution context;
copying the parallel execution context;
modifying the parallel execution context; and
executing instructions referenced in said parallel execution context concurrently by multiple threads.

7. The article of claim 6, wherein parallel execution context comprises at least a reference to instructions to be executed concurrently, a reference to data said instruction may depend on, and a parallelism level indicator initialized to the number of times said instructions are to be executed.

8. The article of claim 6, wherein copying the parallel execution context comprises at least duplicating data referenced in said context to enable independent access to said data from multiple threads.

9. The article of claim 6, wherein modifying the parallel execution context comprises at least updating the parallelism level indicator in accordance with the actual number of times a thread executed instructions referenced in the parallel execution context.

10. The article of claim 6, wherein multiple threads comprise software threads executed by processors and operating on behalf of any combination of said processors, other processing devices and computer systems.

11. A processing system for concurrent execution of instructions comprising:
logic to form a parallel execution context;
logic to copy the parallel execution context;
logic to modify the parallel execution context; and
logic to execute instructions referenced in said parallel execution context concurrently by multiple threads.

12. The system of claim 11, wherein parallel execution context comprises logic to retain at least a reference to instructions to be executed concurrently, a reference to data said instruction may depend on, and a parallelism level indicator initialized to the number of times said instructions are to be executed.

13. The system of claim 11, wherein logic to copy the parallel execution context comprises at least logic to duplicate data referenced in said context to enable independent access to said data from multiple threads.

14. The system of claim 11, wherein logic to modify the parallel execution context comprises at least logic to update the parallelism level indicator in accordance with the actual number of times a thread executed instructions referenced in the parallel execution context.

15. The system of claim 11, wherein multiple threads comprise any combination of processors and processors operating on behalf of any combination of other processing devices and computer systems.
